(19) United States
(12) Patent Application Publication
(10) Pub. No.: US 2025/0385288 A1
(43) Pub. Date: Dec. 18, 2025

(54) FUEL CELL STACK

(71) Applicant: HONDA MOTOR CO., LTD., Tokyo (JP)

(72) Inventor: Kenji NAGUMO, Saitama (JP)

(21) Appl. No.: 19/234,287

(22) Filed: Jun. 11, 2025

(30) Foreign Application Priority Data
Jun. 14, 2024 (JP) 2024-096594

(51) Int. Cl. H01M 8/1004; H01M 8/0258; H01M 8/04082; H01M 8/10

(52) U.S. Cl. CPC H01M 8/1004; H01M 8/0258; H01M 8/04201; H01M 2008/1095

(57) ABSTRACT

A fuel cell stack includes an electrolyte membrane-electrode structure in which a solid polymer electrolyte membrane is sandwiched between an anode electrode and a cathode electrode, and is configured to generate power by an electrochemical reaction between an oxidant gas and a fuel gas. The fuel cell stack includes: a cell to which the oxidant gas and/or the fuel gas is supplied; an oxidant gas supply passage for supplying the oxidant gas to the cell; an oxidant off-gas flow passage through which the oxidant gas discharged from the cell flows; and a communication passage connecting the oxidant gas supply passage and the oxidant off-gas flow passage. A pressure at a first opening through which the communication passage is connected to the oxidant gas supply passage is lower than a pressure at a second opening through which the communication passage is connected to the oxidant off-gas flow passage).

This application is based on and claims the benefit of priority from Japanese Patent Application No. 2024-096594, filed on 14 Jun. 2024, the content of which is incorporated herein by reference.

### BACKGROUND OF THE INVENTION

### Field of the Invention

The present invention relates to a fuel cell stack.

### Related Art

In recent years, research and development has been conducted on fuel cells that contribute to energy efficiency in order to ensure that more people have access to affordable, reliable, sustainable, and advanced energy.

In an electrolyte membrane-electrode structure in which a solid polymer electrolyte membrane is sandwiched between an anode electrode and a cathode electrode, power is generated by an electrochemical reaction between the fuel gas supplied to the anode electrode and the oxidant gas supplied to the cathode electrode. At this time, in order to transfer protons generated at the anode electrode to the cathode electrode to cause proton conduction, it is necessary to put the electrolyte membrane in a wet state. Therefore, a technique in which a humidifier is provided in an oxidant gas supply passage is known.
Patent Document 1: Japanese Unexamined Patent Application, Publication No. 2017-157281

### SUMMARY OF THE INVENTION

The addition of a separate device, a humidifier, not only increases manufacturing costs, but also requires a dedicated space in the fuel cell stack and increases power consumption. Additionally, energy efficiency has been demanded.

A first aspect of the present invention relates to a fuel cell stack (e.g., fuel cell stack 1) including an electrolyte membrane-electrode structure (e.g., electrolyte membrane-electrode structure 20) in which a solid polymer electrolyte membrane (e.g., solid polymer electrolyte membrane 21) is sandwiched between an anode electrode (e.g., anode electrode 22) and a cathode electrode (e.g., cathode electrode 23), the fuel cell stack being configured to generate power by an electrochemical reaction between an oxidant gas and a fuel gas. The fuel cell stack includes: a cell (e.g., cell 11) to which the oxidant gas and/or the fuel gas is supplied; an oxidant gas supply passage (e.g., oxidant gas supply passage 31) for supplying the oxidant gas to the cell; an oxidant off-gas flow passage (e.g., oxidant off-gas flow passage 32) through which the oxidant gas discharged from the cell flows; and a communication passage (e.g., communication passage 40) connecting the oxidant gas supply passage and the oxidant off-gas flow passage. A pressure at a first opening (e.g., first opening 41) through which the communication passage is connected to the oxidant gas supply passage is lower than a pressure at a second opening (e.g., second opening 42) through which the communication passage is connected to the oxidant off-gas flow passage.

In a second aspect of the present invention, it is preferable that a diameter of the oxidant gas supply passage at a position where the first opening is provided is smaller than a diameter of the oxidant gas supply passage at a periphery of the first opening.

In a third aspect of the present invention, it is preferable that a plurality of the cells are stacked to form a stack (e.g., stack 10). It is preferable that a terminal plate (e.g., terminal plate 15), an insulating plate (e.g., insulating plate 16), and an end plate (e.g., end plate 17) are provided in this order from an inside toward an outside of the stack at an end portion of the stack in a stacking direction. The communication passage is preferably formed between the terminal plate and the end plate.

In a fourth aspect of the present invention, the communication passage is preferably formed inside the insulating plate.

According to the first aspect, since the water vapor contained in the oxidant off-gas flow passage 32 is supplied from the second opening 42 of the communication passage 40 connected to the oxidant off-gas flow passage 32 to the first opening 41 of the communication passage 40 connected to the oxidant gas supply passage 31 via the communication passage 40, moisture circulates and drying of the electrolyte membrane-electrode structure 20 can be suppressed. Additionally, since moisture such as water vapor circulates through the communication passage 40, drying of the electrolyte membrane-electrode structure 20 can be suppressed without providing an additional device such as a humidifier or a hydrogen pump, and thus manufacturing costs, power consumption, and the like can be reduced. This contributes to energy efficiency.

According to the second aspect, the diameter D1 of the oxidant gas supply passage 31 at the position where the first opening 41 is provided is configured to be smaller than the diameter of the oxidant gas supply passage 31 at the periphery P of the first opening 41. This allows the pressure at the first opening 41 of the communication passage 40 to the oxidant gas supply passage 31 to be lowered with a simple configuration and allows moisture to efficiently circulate.

According to the third aspect, by arranging the communication passage 40 between the terminal plate 15 and the end plate 17 in the fuel cell stack 1, it is possible to reduce the size of the fuel cell stack 1 in which moisture circulates.

According to the fourth aspect, the communication passage 40 can be easily formed without changing other elements, and the same effect as that of steam can be obtained.

### BRIEF DESCRIPTION OF THE DRAWINGS

FIG. 1 is a schematic view of a fuel cell stack of the present embodiment;

FIG. 2 shows a power generation cell of the present embodiment; and

FIG. 3 is a cross-sectional view taken along arrows A-A in FIG. 1.

### DETAILED DESCRIPTION OF THE INVENTION

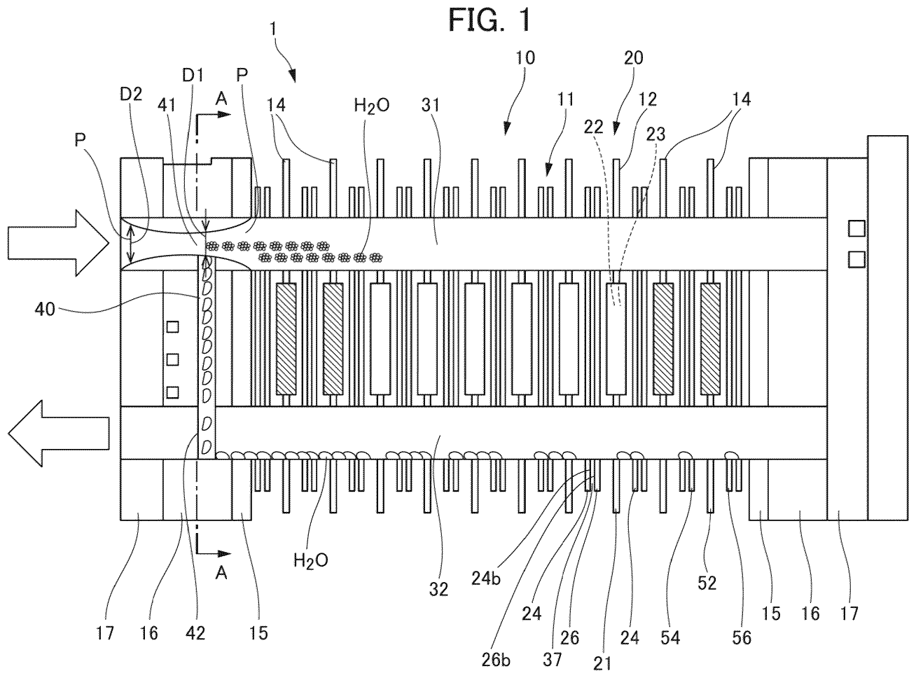

Hereinafter, an embodiment of the present disclosure will be described in detail with reference to the drawings. FIG. 1 schematically shows the configuration of a fuel cell stack 1 of the present embodiment. As shown in FIG. 1, the fuel cell stack 1 includes a stack 10 in which a plurality of cells 11 are stacked. A terminal plate 15, an insulating plate 16, and an end plate 17 are arranged in this order from the inside toward the outside of the stack 10 at each of the end portions of the stack 10 in the stacking direction.

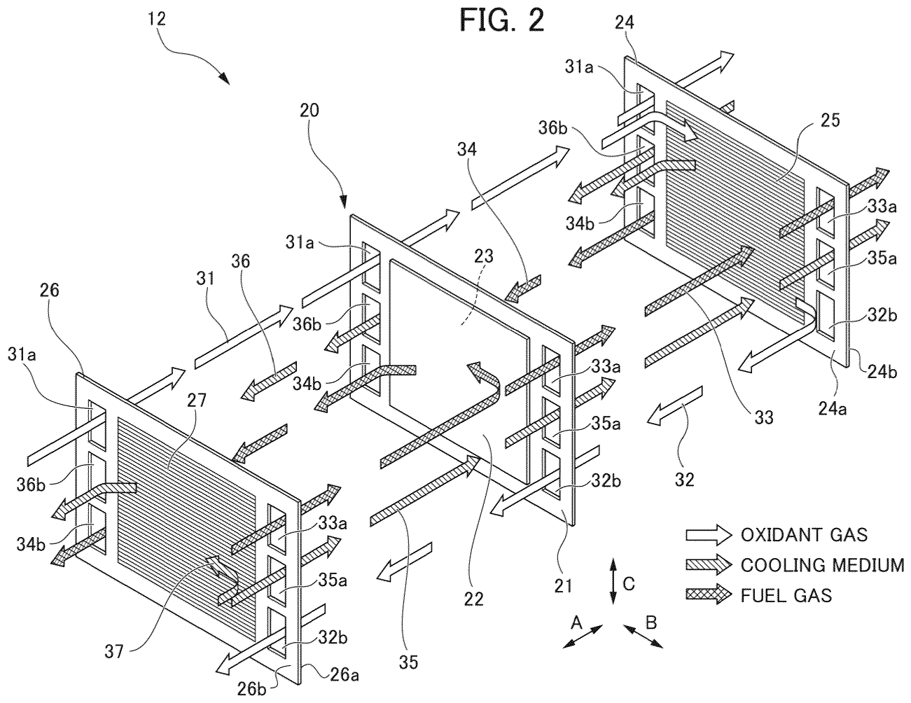

As shown in FIGS. 1 and 2, the fuel cell stack 1 is configured such that an oxidant gas, a fuel gas, and a cooling medium can flow inside and outside the cell 11. The fuel cell stack 1 includes an oxidant gas supply passage 31, an oxidant off-gas flow passage 32, a communication passage 40, a fuel gas supply passage 33 (hereinafter, see FIG. 2), a fuel off-gas flow passage 34, a cooling medium supply passage 35, and a cooling medium discharge passage 36.

The cell 11 includes a power generation cell 12 and a dummy cell 14. FIG. 2 illustrates the configuration of the power generation cell 12. As shown in FIG. 2, the power generation cell 12 includes an electrolyte membrane-electrode structure 20, and a first metal separator 24 and a second metal separator 26 sandwiching the electrolyte membrane-electrode structure 20. Although not shown, a seal member such as a gasket is interposed between the electrolyte membrane-electrode structure 20 and each of the first metal separator 24 and the second metal separator 26 so as to cover the periphery of various communication holes described later and the outer periphery of the electrode surface (power generation surface).

At one end edge portion of the power generation cell 12 in the direction of arrow B, oxidant gas supply communication holes 31a for supplying an oxidant gas, for example, an oxygen-containing gas, cooling medium discharge communication holes 36b for discharging a cooling medium, and fuel gas discharge communication holes 34b for discharging a fuel gas, for example, a hydrogen-containing gas are provided so as to be arranged in the direction of arrow C (vertical direction). The oxidant gas supply communication holes 31a are in communication with each other in the direction of arrow A that is the stacking direction. The same is true for the cooling medium discharge communication holes 36b and the fuel gas discharge communication holes 34b.

At the other end edge portion of the power generation cell 12 in the direction of arrow B, fuel gas supply communication holes 33a for supplying a fuel gas, cooling medium supply communication holes 35a for supplying a cooling medium, and oxidant gas discharge communication holes 32b for discharging an oxidant gas are provided so as to be arranged in the direction of arrow C. The fuel gas supply communication holes 33a are in communication with each other in the direction of arrow A. The same is true for the cooling medium supply communication holes 35a and the oxidant gas discharge communication holes 32b.

The oxidant gas supply communication holes 31a formed in each power generation cell 12 forms the oxidant gas supply passage 31 for supplying the oxidant gas to the power generation cell 12 in a state where a plurality of power generation cells 12 are stacked side by side as shown in FIG. 1. The oxidant gas discharge communication holes 32b form the oxidant off-gas flow passage 32 through which the oxidant gas discharged from the power generation cells 12 flows in a state where the plurality of power generation cells 12 are stacked side by side. FIG. 1 only schematically shows the flow of the oxidant gas in the oxidant gas supply passage 31 and the oxidant off-gas flow passage 32 to indicate the communication passage 40 described later, and the fuel gas supply passage 33, the fuel off-gas flow passage 34, the cooling medium supply passage 35, and the cooling medium discharge passage 36 are not shown.

The fuel gas supply communication holes 33a formed in each power generation cell 12 form the fuel gas supply passage 33 for supplying the fuel gas to the power generation cells 12 in a state where the plurality of power generation cells 12 are stacked side by side. The fuel gas discharge communication holes 34b form the fuel off-gas flow passage 34 through which the fuel off-gas discharged from the power generation cells 12 flows in a state where the plurality of power generation cells 12 are stacked side by side.

The cooling medium supply communication holes 35a formed in each power generation cell 12 form the cooling medium supply passage 35 for supplying a cooling medium to the first metal separator 24 and the second metal separator 26 described later in a state where the plurality of power generation cells 12 are stacked side by side. The cooling medium discharge communication holes 36b form the cooling medium discharge passage 36 through which the cooling medium discharged from the first metal separator 24 and the second metal separator 26 described later, flows.

The electrolyte membrane-electrode structure 20 includes, for example, a solid polymer electrolyte membrane 21 in which a thin membrane of perfluorosulfonic acid is impregnated with water, and an anode electrode 22 and a cathode electrode 23 sandwiching the solid polymer electrolyte membrane 21 (see FIGS. 1 and 2).

Each of the anode electrode 22 and the cathode electrode 23 includes a gas diffusion layer made of carbon paper or the like, and an electrode catalyst layer in which porous carbon particles having a platinum alloy supported on the surface thereof are uniformly applied to the surface of the gas diffusion layer. The electrode catalyst layers are bonded to both surfaces of the solid polymer electrolyte membrane 21 so as to face each other with the solid polymer electrolyte membrane 21 interposed therebetween.

The first metal separator 24 and the second metal separator 26 are each made of, for example, metal or carbon, and are arranged so as to sandwich the electrolyte membrane-electrode structure 20.

As shown in FIG. 2, an oxidant gas flow groove portion 25 communicating with the oxidant gas supply communication hole 31a and the oxidant gas discharge communication hole 32b is provided on a surface 24a of the first metal separator 24 on the electrolyte membrane-electrode structure 20 side. The oxidant gas flow groove portion 25 is formed such that a plurality of grooves extending in the direction of arrow B are formed on the surface 24a of the first metal separator 24, and the oxidant gas flows between the grooves and the cathode electrode 23. Inside the oxidant gas flow groove portion 25, the oxidant gas flows in the direction of arrow B. The oxidant gas flow groove portion 25 is supplied with the oxidant gas from the oxidant gas supply passage 31 and discharges the oxidant gas to the oxidant off-gas flow passage 32.

A fuel gas flow groove portion 27 communicating with the fuel gas supply communication hole 33a and the fuel gas discharge communication hole 34b is formed on a surface 26a of the second metal separator 26 on the electrolyte membrane-electrode structure 20 side. The fuel gas flow groove portion 27 is formed such that a plurality of grooves extending in the direction of arrow B are formed on the surface 26a of the second metal separator 26, and the fuel gas flows between the grooves and the anode electrode 22. Inside the fuel gas flow groove portion 27, the fuel gas flows in the direction of arrow B. The fuel gas flow groove portion 27 is supplied with the fuel gas from the fuel gas supply passage 33 and discharges the fuel gas to the fuel off-gas flow passage 34.

As shown in FIG. 1, in a state where the plurality of power generation cells 12 are stacked, a cooling medium flow groove portion 37 in communication with the cooling medium supply communication hole 35a and the cooling medium discharge communication hole 36b is formed between the surface 24b of the first metal separator 24 and the surface 26b of the second metal separator 26 that are adjacent to each other. The cooling medium flow groove portion 37 is integrally formed by overlapping a plurality of grooves provided in the first metal separator 24 and a plurality of grooves provided in the second metal separator 26 so as to extend in the direction of arrow B. Inside the cooling medium flow groove portion 37, the cooling medium flows in the direction of arrow B. The cooling medium flow groove portion 37 is supplied with the cooling medium from the cooling medium supply passage 35 and discharges the cooling medium to the cooling medium discharge passage 36.

As shown in FIG. 1, the dummy cell 14 includes a conductive plate 52 corresponding to the electrolyte membrane-electrode structure 20, and a dummy cell first metal separator 54 and a dummy cell second metal separator 56 sandwiching the conductive plate 52. The conductive plate 52 includes, for example, a metal plate, and is configured to be substantially identical to the electrolyte membrane-electrode structure 20. However, the dummy cell 14 does not include the electrolyte membrane-electrode structure 20 and does not generate water generated by power generation.

The dummy cell first metal separator 54 and the dummy cell second metal separator 56 each include an oxidant gas supply communication hole 31a, a cooling medium discharge communication hole 36b, a fuel gas discharge communication hole 34b, a fuel gas supply communication hole 33a, a cooling medium supply communication hole 35a, and an oxidant gas discharge communication hole 32b. The oxidant gas supply communication hole 31a, the cooling medium discharge communication hole 36b, and the fuel gas discharge communication hole 34b are arranged in the direction of arrow C (vertical direction) at one end edge portion of each of the dummy cell first metal separator 54 and the dummy cell second metal separator 56 in the direction of arrow B. The fuel gas supply communication hole 33a, the cooling medium supply communication hole 35a, and the oxidant gas discharge communication hole 32b are arranged in the direction of arrow C at the other end edge portion of each of the dummy cell first metal separator 54 and the dummy cell second metal separator 56 in the direction of arrow B. The dummy cell 14 allows the water vapor flowing into the oxidant gas supply passage 31 to flow through a plurality of grooves provided in the dummy cell first metal separator 54 and the dummy cell second metal separator 56 and extending in the direction of arrow B, thereby preventing the water vapor from excessively flowing into the power generation cell 12.

The terminal plates 15 are respectively arranged at one end and the other end of the stack 10, and sandwich the stack 10. The terminal plates 15 are made of an electrically conductive material.

The insulating plates 16 are arranged side by side with the terminal plates 15 on the outer sides of the terminal plates 15 in the stacking direction. The insulating plate 16 is made of, for example, an insulating material such as polycarbonate or phenol resin, and is formed thicker than the terminal plate 15 in the stacking direction as shown in FIG. 1.

The end plates 17 are arranged side by side with the insulating plate 16 on the outer side of the insulating plate 16 in the stacking direction. The end plates 17 are located on the outermost sides of the fuel cell stack 1.

In each of the terminal plate 15, the insulating plate 16, and the end plate 17, the above-described oxidant gas supply communication hole 31a, the oxidant gas discharge communication hole 32b, the cooling medium supply communication hole 35a, the cooling medium discharge communication hole 36b, the fuel gas discharge communication hole 34b, and the fuel gas supply communication hole 33a are formed, and the oxidant gas, the hydrogen gas, and the cooling medium can be supplied from the outside of the fuel cell stack 1 and discharged to the outside. Therefore, the oxidant gas supply passage 31 and the oxidant off-gas flow passage 32 are formed to penetrate the terminal plates 15, the insulating plates 16, and the end plate 17. As shown in FIG. 1, the oxidant gas supply passage 31 penetrating the terminal plates 15, the insulating plates 16, and the end plate 17 is formed to be narrowed so that the inner diameter of the oxidant gas supply passage 31 is smaller than the interior of the stack 10. With respect to the narrowing of the oxidant gas supply passage 31, in the case where the oxidant gas supply passage 31 is configured to form a circular passage at the center, the oxidant gas supply passage 31 has an inner diameter, but the passage is not limited to being circular. In the case where the passage is not circular, the passage is narrowed such that the distance between two opposing points is small in the inner wall of the oxidant gas supply passage 31.

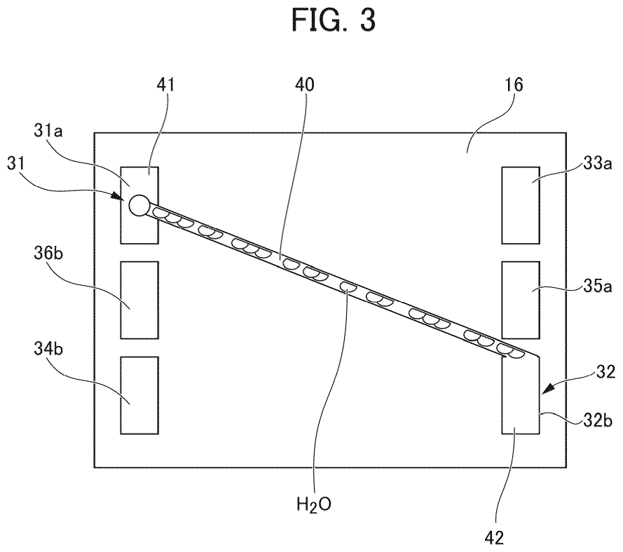

As shown in FIG. 3, the communication passage 40 is formed inside the insulating plate 16 so as to connect the oxidant gas supply passage 31 and the oxidant off-gas flow passage 32. Specifically, a pipe connecting the oxidant gas supply communication hole 31a and the oxidant gas discharge communication hole 32b formed in the insulating plate 16 is provided, and a space through which the oxidant gas can flow is formed. Here, the oxidant gas supply communication hole 31a of the insulating plate 16 at the position where the communication passage 40 is connected is referred to as a first opening 41, and the oxidant gas discharge communication hole 32b of the insulating plate 16 at the position where the communication passage 40 is connected is referred to as a second opening 42. Accordingly, the first opening 41 is an opening through which the communication passage 40 is connected to the oxidant gas supply passage 31, and the second opening 42 is an opening through which the communication passage 40 is connected to the oxidant off-gas flow passage 32.

As shown in FIG. 1, the diameter D1 of the oxidant gas supply passage 31 at the position where the first opening 41 is provided is smaller than the diameter D2 of the oxidant gas supply passage 31 at the periphery P of the position where the first opening 41 is provided. In the case where the shape of the first opening 41 is not circular, the distance between two opposing points in the first opening 41 is smaller than the distance between two opposing points of the oxidant gas supply passage 31 at the periphery P of the position where the first opening 41 is provided. That is, at the position where the first opening 41 is provided, the first opening 41 side becomes narrower than the periphery P thereof, and the oxidant gas supply passage 31 becomes thinner. Therefore, due to the Venturi effect, the pressure at the first opening 41 is lower than that at the periphery P thereof. The “periphery P” refers to a position away from the first opening 41 to the upstream side or the downstream side of the oxidant gas supply passage 31, and may refer to a position close to the opening and formed on the end plate 17 side or the terminal plate 15 side, as shown in FIG. 1, for example. A certain portion passing through the first opening 41 between the downstream side of the end plate 17 and the upstream side of the terminal plate 15 may be formed to be continuously narrowed. The continuous narrow portion may gradually increase in diameter toward the downstream side of the end plate 17 and the upstream side of the terminal plate 15.

When the pressure at the first opening 41 is compared with the pressure at the second opening 42 connected to the oxidant off-gas flow passage 32, which is not reduced in diameter, the pressure at the first opening 41 is lower than the pressure at the second opening 42.

The operation of the fuel cell stack 1 configured as described above will be described below. As shown in FIG. 1, in the fuel cell stack 1, a fuel gas such as a hydrogen-containing gas, an oxidant gas that is an oxygen-containing gas such as air, and a cooling medium such as pure water, ethylene glycol, or oil are supplied to the stack 10 in which the plurality of power generation cells 12 and dummy cells 14 are stacked.

As shown in FIG. 2, in each power generation cell 12, the fuel gas is introduced from the fuel gas supply communication hole 33a into the fuel gas flow groove portion 27 of the second metal separator 26 and moves along the anode electrode 22 constituting the electrolyte membrane-electrode structure 20. The oxidant gas is introduced from the oxidant gas supply communication hole 31a into the oxidant gas flow groove portion 25 of the first metal separator 24 and moves along the cathode electrode 23 constituting the electrolyte membrane-electrode structure 20.

In the electrolyte membrane-electrode structure 20, the fuel gas supplied to the anode electrode 22 and the oxidant gas supplied to the cathode electrode 23 are consumed by an electrochemical reaction in the electrode catalyst layer to generate power. In the catalyst layer of the anode electrode 22, hydrogen in the fuel gas lose their electrons to generate hydrogen ions, which then move through the electrolyte membrane to the cathode side. In the catalyst layer of the cathode electrode 23, the hydrogen ions react with oxygen in the oxidant gas to generate generated water.

In this way, generated water is generated on the cathode side. A part of the generated water moves to the anode side through the electrolyte membrane.

The oxidant gas supplied to and consumed by the cathode electrode 23 is discharged along the oxidant off-gas flow passage 32 formed of the oxidant gas discharge communication hole 32b in the direction of arrow A. The fuel gas supplied to and consumed by the anode 22 is discharged along the fuel off-gas flow passage 34 formed of the fuel gas discharge communication passage 34b in the direction of arrow A.

The cooling medium supplied to the cooling medium supply communication hole 35a is introduced into the cooling medium flow groove portion 37 between the first metal separator 24 and the second metal separator 26, and then flows along the direction of arrow B. After cooling the electrolyte membrane-electrode structure 20, the cooling medium is discharged from the cooling medium discharge passage 36 formed of the cooling medium discharge communication hole 36b.

The oxidant gas supply passage 31 and the oxidant off-gas flow passage 32 are connected by the communication passage 40. Since the pressure on the side of the first opening 41 connected to the oxidant gas supply passage 31 is lower than the pressure on the side of the second opening 42 connected to the oxidant off-gas flow passage 32, a passage of the oxidant gas flowing from a higher pressure side to a lower pressure side is formed. Therefore, a part of the oxidant off-gas containing the generated water is drawn from the second opening 42 toward the first opening 41 through the communication passage 40, downstream of the oxidant off-gas flow passage 32. The part of the oxidant off-gas containing the generated water mixes with the newly supplied oxidant gas and joins the oxidant gas supply passage 31. Depending on the flow rate of the oxidant gas, the water vapor changes into a spray form and flows through the oxidant gas supply passage 31. In this way, the oxidant gas containing a large amount of water vapor circulates through the communication passage 40, the oxidant gas supply passage 31, and the oxidant off-gas flow passage 32.

(1) According to the present embodiment, the following effects are achieved. A fuel cell stack 1 includes an electrolyte membrane-electrode structure 20 in which a solid polymer electrolyte membrane 21 is sandwiched between an anode electrode 22 and a cathode electrode 23, and the fuel cell stack 1 is configured to generate power by an electrochemical reaction between an oxidant gas and a fuel gas. The fuel cell stack 1 includes a cell 11 to which the oxidant gas and/or the fuel gas is supplied; an oxidant gas supply passage 31 for supplying the oxidant gas to the cell 11; an oxidant off-gas flow passage 32 through which the oxidant gas discharged from the cell 11 flows; and a communication passage 40 connecting the oxidant gas supply passage 31 and the oxidant off-gas flow passage 32. The pressure at a first opening 41 through which the communication passage 40 is connected to the oxidant gas supply passage 31 is configured to be lower than the pressure at a second opening 42 through which the communication passage 40 is connected to the oxidant off-gas flow passage 32. Since the water vapor contained in the oxidant off-gas flow passage 32 is supplied from the second opening 42 of the communication passage 40 connected to the oxidant off-gas flow passage 32 to the first opening 41 of the communication passage 40 connected to the oxidant gas supply passage 31 via the communication passage 40, moisture circulates and drying of the electrolyte membrane-electrode structure 20 can be suppressed. Additionally, since moisture such as water vapor circulates through the communication passage 40, drying of the electrolyte membrane-electrode structure 20 can be suppressed without providing an additional device such as a humidifier or a hydrogen pump, and thus manufacturing costs, power consumption, and the like can be reduced. This contributes to energy efficiency.

(2) According to the present embodiment, the diameter D1 of the oxidant gas supply passage 31 at a position where the first opening 41 is provided is configured to be smaller than the diameter of the oxidant gas supply passage 31 at the periphery P of the first opening 41. This allows the pressure at the first opening 41 of the communication passage 40 to the oxidant gas supply passage 31 to be lowered with a simple configuration and allows moisture to efficiently circulate.

(3) According to the present embodiment, a plurality of the cells 11 are stacked to form a stack 10. A terminal plate 15, an insulating plate 16, and an end plate 17 are provided in this order from the inside toward the outside of the stack 10 at an end portion of the stack 10 in the stacking direction. The communication passage 40 is formed between the terminal plate 15 and the end plate 17. By arranging the communication passage 40 between the terminal plate 15 and the end plate 17 in the fuel cell stack 1, it is possible to reduce the size of the fuel cell stack 1 in which moisture circulates.

(4) According to the present embodiment, the communication passage 40 is formed inside the insulating plate 16. This makes it possible to easily form the communication passage 40 without changing other elements, and provides the same effect as that of steam.

In the embodiment described above, both the oxidant gas and the fuel gas are supplied to the power generation cell 12, and both the oxidant gas and the fuel gas are supplied to the dummy cell 14. However, the dummy cell 14 may be configured to be supplied with only one of the gases.

In the embodiment described above, the communication passage 40 is disposed inside the insulating plate 16, but the position of the communication passage 40 is not limited to inside the insulating plate 16. The communication passage 40 may be formed between the terminal plate and the end plate in the stacking direction, may be formed in the terminal plate or the end plate, or may be formed across a plurality of plates.

### EXPLANATION OF REFERENCE NUMERALS

1 fuel cell stack
10 stack
11 cell
15 terminal plate
16 insulating plate
17 endplate
20 electrolyte membrane-electrode structure
21 solid polymer electrolyte membrane
22 anode electrode
23 cathode electrode
31 oxidant gas supply passage
32 oxidant off-gas flow passage
40 communication passage
41 first opening
42 second opening

What is claimed is:

1. A fuel cell stack comprising an electrolyte membrane-electrode structure in which a solid polymer electrolyte membrane is sandwiched between an anode electrode and a cathode electrode, the fuel cell stack being configured to generate power by an electrochemical reaction between an oxidant gas and a fuel gas,
the fuel cell stack comprising:
a cell to which the oxidant gas and/or the fuel gas is supplied;
an oxidant gas supply passage for supplying the oxidant gas to the cell;
an oxidant off-gas flow passage through which the oxidant gas discharged from the cell flows; and
a communication passage connecting the oxidant gas supply passage and the oxidant off-gas flow passage,
wherein a pressure at a first opening through which the communication passage is connected to the oxidant gas supply passage is lower than a pressure at a second opening through which the communication passage is connected to the oxidant off-gas flow passage.

2. The fuel cell stack according to claim 1,
wherein a diameter of the oxidant gas supply passage at a position where the first opening is provided is smaller than a diameter of the oxidant gas supply passage at a periphery of the first opening.

3. The fuel cell stack according to claim 1,
wherein a plurality of the cells are stacked to form a stack,
wherein a terminal plate, an insulating plate, and an end plate are provided in this order from an inside toward an outside of the stack at an end portion of the stack in a stacking direction, and
wherein the communication passage is formed between the terminal plate and the end plate.

4. The fuel cell stack according to claim 2,
wherein a plurality of the cells are stacked to form a stack,
wherein a terminal plate, an insulating plate, and an end plate are provided in this order from an inside toward an outside of the stack at an end portion of the stack in a stacking direction, and
wherein the communication passage is formed between the terminal plate and the end plate.

5. The fuel cell stack according to claim 3,
wherein the communication passage is formed inside the insulating plate.

6. The fuel cell stack according to claim 4,
wherein the communication passage is formed inside the insulating plate.
